(19) United States
(12) Patent Application Publication
(10) Pub. No.: US 2024/0413666 A1
(43) Pub. Date: Dec. 12, 2024

(54) PERIPHERAL DEVICE WIRELESS CHARGE RATE CONTROL

(71) Applicant: Hewlett-Packard Development Company, L.P., Spring, TX (US)

(72) Inventors: HUAI-YUNG YEN, Taipei City (TW); RUEI-TING LIN, Taipei City (TW); CHENG-FANG LIN, Taipei City (TW); REN-HAO CHEN, Taipei City (TW); LO-CHUN TUNG, Taipei City (TW)

(73) Assignee: Hewlett-Packard Development Company, L.P., Spring, TX (US)

(21) Appl. No.: 18/702,731

(22) PCT Filed: Nov. 30, 2021
(86) PCT No.: PCT/US2021/061253

§ 371 Date: Apr. 18, 2024

(51) Int. Cl. H02J 50/20; G06F 1/26; H02J 7/00

(52) U.S. Cl. CPC H02J 50/20; G06F 1/266; H02J 7/0048; H02J 7/007182

(57) ABSTRACT

An example computing device includes a wireless communication device, such as a wireless wide area network (WWAN) communication device, that communicates in a first band of electromagnetic radiation, and a wireless charging system that wirelessly charges a peripheral device using a second band of electromagnetic radiation. The wireless charging system operating in the first band may introduce harmonic noise that negatively impacts communication in the second band. Accordingly, in various examples, the system operates to adjust the charge rate used by the wireless charging system based on a function of the charge state of the peripheral device and a received signal strength indicator (RSSI) value of a signal received by the wireless communication device. In some instances, the wireless charging rate of the peripheral device may be disabled or reduced when the RSSI value of the signal received by the wireless communication device is below a threshold value.

### BACKGROUND

The use of electronic devices, such as mobile phones, tablet devices, and laptop computers, has increased in recent years. Some of these devices utilize wireless wide area network (WWAN) communication systems to maintain network connectivity during mobile or remote operating conditions. Some electronic devices include a peripheral device, such as a speaker, microphone, or an input device (e.g., a stylus, mouse, pointer device, or button clicker) that can be wirelessly charged via a wireless charging system of the electronic device.

### BRIEF DESCRIPTION OF THE DRAWINGS

Non-limiting and non-exhaustive examples of the disclosure are described, including various examples of the disclosure, with reference to the figures described below.

FIG. 1 is an example graph that illustrates interference in a wireless wide area network (WWAN) band caused by wireless charging using a near-field communication (NFC) band.

FIG. 2A illustrates an example computing device with an NFC wireless charging system that adjusts a charge rate based on a receive signal strength indicator (RSSI) value from a WWAN wireless communication system.

FIG. 2B illustrates another example computing device with an NFC wireless charging system that adjusts a charge rate based on an RSSI value from a WWAN wireless communication system.

FIG. 3A illustrates a flow chart of an example approach for controlling the wireless charge rate of a wireless charging system as a function of the impact on a wireless communication system.

FIG. 3B illustrates a flow chart of another example approach for controlling the wireless charge rate of a wireless charging system as a function of the impact on a wireless communication system.

FIG. 4 illustrates a table of charge rates for an example NFC wireless charging system.

FIG. 5 illustrates an example graphical user interface for a user to manually assign network priority status to individual applications.

FIG. 6 illustrates a block diagram of an example system with a wireless charging system and a wireless communication system.

### DETAILED DESCRIPTION

According to various examples, a computing device includes a processor, a wireless communication system, a wireless charging system, and a non-transitory computer-readable medium. The wireless communication system may facilitate wireless communication via a first band of electromagnetic radiation. In one example, the wireless communication system comprises a wireless wide area network (WWAN) communication system that communicates using electromagnetic radiation at a frequency between approximately 700 MHz and 900 MHz. The wireless charging system may be adapted to charge a peripheral device using, for example, a near-field communication (NFC) protocol and associated frequency band. For example, an NFC wireless charging system may utilize electromagnetic radiation at a frequency of 13.56 MHz.

In various examples, the wireless charging system is configured to charge a stylus. In other examples, the wireless charging system is configured to charge one or more of a wide variety of different peripheral devices including, but not limited to, headphones, a microphone, a camera, a mobile phone, an input device, a joystick, a removable trackpad, a mouse, a keyboard, or a combination thereof. Accordingly, the wireless charging system charges a peripheral device that, in some examples, comprises an input device selected from a group of input devices that includes a mouse, a keyboard, a stylus, a speaker, headphones, a microphone, and a camera.

In some instances, operations of the wireless charging system using electromagnetic radiation in a second band (e.g., 13.56 MHz) introduces noise or interference (e.g., harmonic noise) in the first band of electromagnetic radiation used by the wireless communication system (e.g., operating at a frequency between 700 MHz and 900 MHz). The noise or interface can, in some instances, degrade the performance of the wireless communication system. In some examples, an RSSI value associated with the wireless communication system is used to quantify the quality or strength of the signal used by the wireless communication system.

In various examples, a charge rate controller allows the wireless charging system to charge at a maximum or default rate as long as the RSSI value of the signal received by the wireless communication system remains above a threshold impact value. The threshold impact value may be specified as a threshold RSSI value, such as −15 dB, −20 dB, −50 dB, −65 dB, or −70 dB. The threshold impact value (e.g., the specific threshold RSSI value utilized) may be determined based on the characteristics of the wireless communication system utilized, the operating conditions, or a combination thereof. As long as the RSSI value of the signal received by the wireless communication system remains above the threshold impact value, the wireless charging system may operate unthrottled. However, if the RSSI value of the wireless communication system drops below the threshold impact value, the charge rate of the wireless charging system is reduced. In some instances, wireless charging may be disabled. The system may verify that the reduced or disabled charge rate of the wireless charging system results in an increased RSSI value of the wireless communication system. In some examples, the system may maintain the reduced or disabled charge rate of the wireless charging system for an established timeout period before increasing the charge rate of the wireless charging system.

In various examples, the charge rate of the wireless charging system is adjusted based on a function of the charge state of the peripheral device and the RSSI value of the signal received by the wireless communication system. For example, if the charge state of the peripheral device is below a low-power threshold, the system may continue to charge the peripheral device at a full or reduced charge rate, even if the RSSI value of the signal received by the wireless communication system is below the threshold impact value.

In some embodiments, a computing system or a user of the computing system may designate one or more applications that execute on the computing system as having network priority status. The system may reduce or disable wireless charging when an application with network priority status is executing on the computing device to minimize or reduce noise or interference that might negatively impact communication via the wireless communication system.

According to one example, the computing device includes instructions stored on the non-transitory computer-readable medium that, when executed by the processor, cause the computing device to adjust the charge rate of the wireless charging system based on the charge state of the peripheral device, the RSSI value of the signal received by the wireless communication system, the network priority state of an application executing on the computing device, or a combination thereof.

For instance, in some examples, the executed instructions operate to adjust the charge rate of the wireless charging system to charge at a full charge rate as long as the RSSI value of the signal received by the wireless communication subsystem is above an impact threshold (e.g., a threshold RSSI value between −15 dB and −70 dB). In some examples, the executed instructions operate to charge at a full charge rate when the RSSI value of the signal received by the wireless communication system is below an impact threshold and the charge state of the peripheral device is below a low-power threshold (e.g., a low-battery state of charge defined between 10% and 60%). Accordingly, in some examples, charging a nearly depleted peripheral device is prioritized over network communications. In some examples, the executed instructions operate to disable charging when the RSSI value of the signal received by the wireless communication system is below an impact threshold and the charge state of the peripheral device is above a low-power threshold.

In some examples, the executed instructions operation to adjust the charge rate of the wireless charging system to charge at a reduced charge rate in response to a determination that the RSSI value of the signal received by the wireless communication system is below an impact threshold, a determination that the charge state of the peripheral device is below a low-power threshold, and the identification of an application executing on the computing device assigned network priority status.

In some examples, the operations for adjusting the charge rate may be performed by a charge rate subsystem of a wireless charge controller. The charge rate subsystem may be, for example, implemented using electronic circuitry, microcontrollers, microprocessors, or a combination thereof.

As described herein, some of the systems and methods described herein may be implemented by a processor of a computing device executing instructions stored on a non-transitory computer-readable medium. The term “non-transitory” does not encompass transitory propagating signals. Execution of the instructions stored on a non-transitory computer-readable medium may cause a computing device to perform various operations or functions, as described herein. The executable instructions may be physically or conceptually divided into discrete modules or blocks of instructions, in some examples.

As used herein, a basic input/output system (BIOS) refers to hardware or hardware and instructions to initialize, control, or operate a computing device prior to the execution of an operating system (OS) of the computing device. Instructions included within a BIOS may be software, firmware, microcode, or another programming that defines or controls the functionality or operation of a BIOS. In one example, a BIOS may be implemented using instructions, such as platform firmware of a computing device, executable by a processor. A BIOS may operate or execute prior to the execution of the OS of a computing device. A BIOS may initialize, control, or operate components such as hardware components of a computing device and may load or boot the OS of a computing device.

In some examples, a BIOS may provide or establish an interface between hardware devices or platform firmware of the computing device and an OS of the computing device, via which the OS of the computing device may control or operate hardware devices or the platform firmware of the computing device. In some examples, a BIOS may implement the Unified Extensible Firmware Interface (UEFI) specification or another specification or standard for initializing, controlling, or operating a computing device.

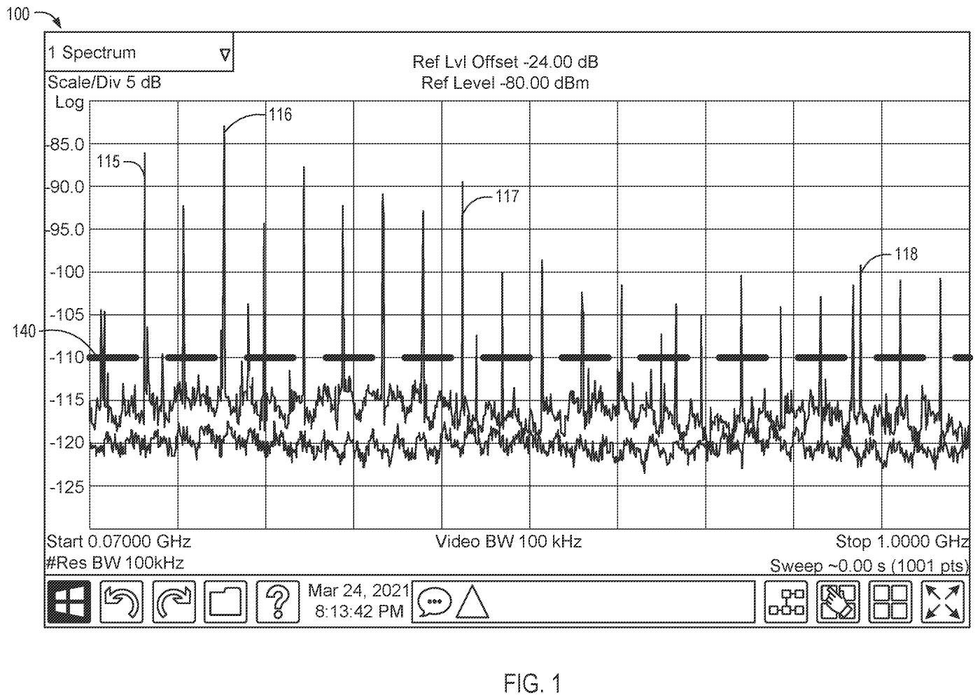

FIG. 1 is an example graph 100 with interference noise spikes between 700 MHz and 1 GHz that exceed a threshold level of acceptability 140. Four of the noise spikes are labeled 115, 116, 117, and 118. The noise spike 116 rises to approximately −25 dB, causing significant interference in a wireless wide area network (WWAN) band. The illustrated noise spikes 115-118 are caused by, for example, wireless charging using a near-field communication (NFC) band. Accordingly, the graph 100 illustrates the detrimental effects that wireless charging via an NFC band can have on a WWWAN band.

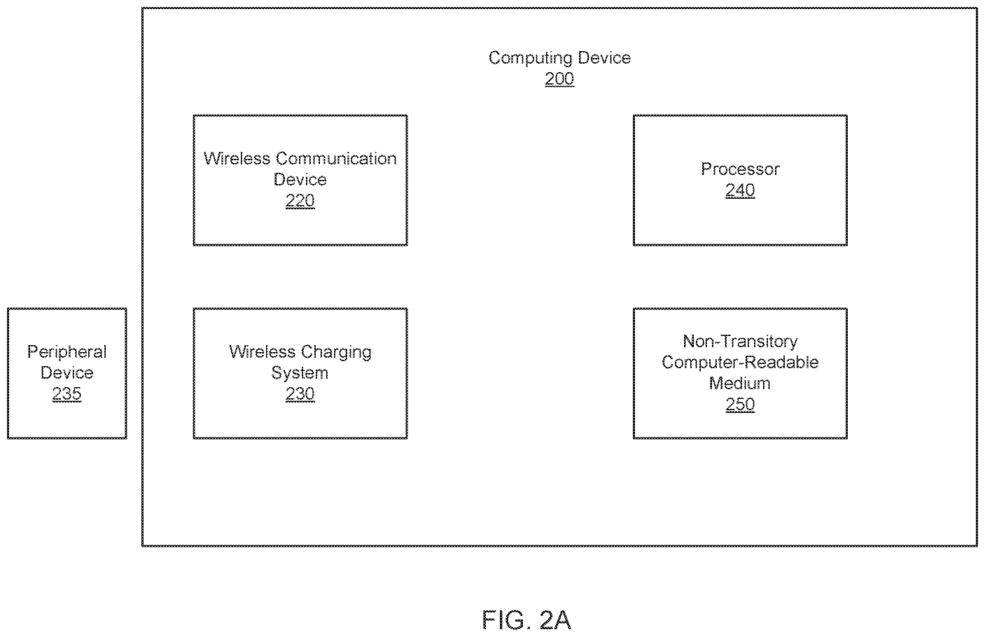

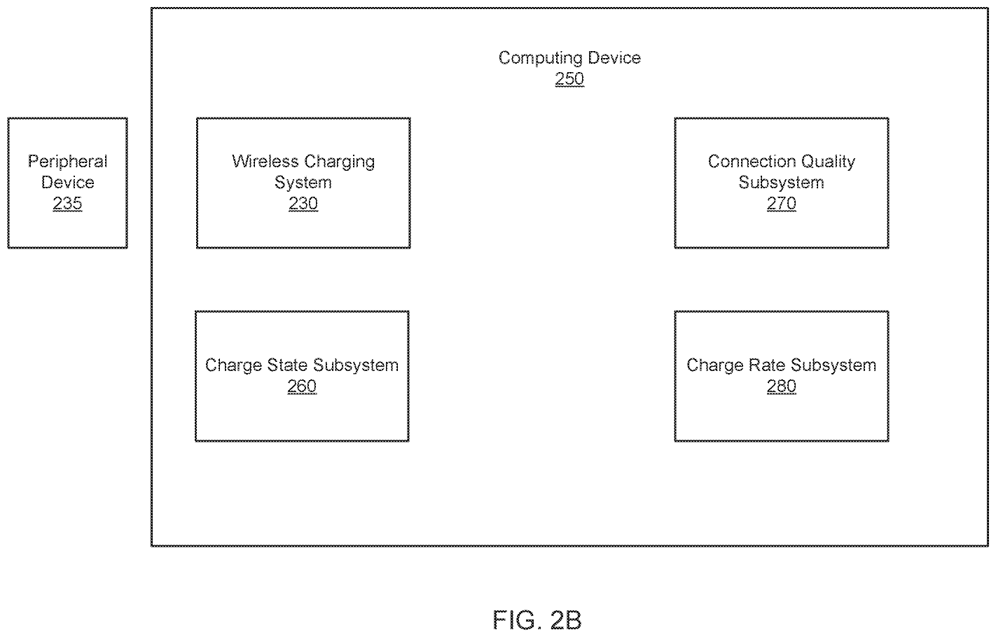

FIG. 2A illustrates an example computing device 200 with an NFC wireless charging system 230 that adjusts a charge rate based on a receive signal strength indicator (RSSI) value from a WWAN wireless communication device 220 (e.g., an RSSI value reported by the WWAN wireless communication device 220, where the RSSI value quantifies a quality or strength metric of a communication signal received by the WWAN communication device 220). In some implementations, a processor 240 may implement these operations by, for example, executing instructions stored within a non-transitory computer-readable medium 250. The computing device 200 may be, for example, a personal computing device such as a mobile phone, a tablet computer, or a laptop computer. The computing device, in some examples, comprises a personal computing device selected from a group of personal computing devices that includes a mobile phone, a tablet computer, and a laptop computer.

The wireless communication device 220 facilitates wireless communication using a first band of electromagnetic radiation. For example, the wireless communication device 220 may be a WWAN communication device that operates using an electromagnetic radiation band between approximately 700 MHz and 900 MHz. In some examples, the wireless charging system 230 is an NFC charging system that operates using an electromagnetic radiation band at approximately 13.56 MHz. As illustrated in FIG. 1, wireless charging may introduce noise, such as harmonic interference, in the electromagnetic radiation band used by the wireless communication device 220.

The wireless charging system 230 may be adapted for and used to charge a peripheral device 235, such as a mouse, a keyboard, a stylus, a speaker, headphones, a microphone, a pointer device, a button clicker, and a camera. The processor 240 may determine the charge state of the peripheral device 235 and a connection quality metric of the wireless communication device. In some examples, the connection quality metric of the wireless communication device 220 is determined based on a receive signal strength indicator (RSSI) value of a communication signal received by the wireless communication device 220.

The processor 240 adjusts the charge rate of the wireless charging system 230 as a function of the charge state of the peripheral device 235 and the connection quality of the wireless communication device 220. For example, the processor 240 may cause the computing device 200 to charge the peripheral device 235 (e.g., a stylus) at (a) a full charge rate in response to a determination that the connection quality metric of the wireless communication device 220 is above an impact threshold; (b) a full charge rate in response to a determination that (i) the connection quality metric of the wireless communication device 220 is below an impact threshold and (ii) the charge state of the peripheral device 235 is below a low-power threshold; and (c) disable charging in response to a determination that (i) the connection quality metric of the wireless communication device 220 is below an impact threshold and (ii) the charge state of the peripheral device 235 is above a low-power threshold.

The computing device 200 may use a default low-power threshold, a low-power threshold value adjusted based on recent usage statistics of the peripheral device 235, a user-adjusted low-power threshold, or a combination thereof. In some examples, the system may use a low-power threshold defined as a state of charge percentage less than 60%. In some examples, the processor 240 of the computing device 200 determines the connection quality metric of the wireless communication devices based on an RSSI value of a communication signal received by the wireless communication device 220. In some examples, the processor 240 uses an impact threshold of a particular RSSI value, such as an RSSI value of −25 dB, −65 db, −70 dB, or the like.

In some examples, the computing device 200 analyzes one or more applications executing on the computing device 200 to identify one or more applications assigned network priority status. The computing device 200 adjusts the charge rate of the wireless charging system 230 as a function of the charge state of the peripheral device 235, the connection quality metric of the wireless communication device 220, and the identification of an application assigned network priority status.

In various examples, the processor 240 operates to adjust the charge rate of the wireless charging system to charge at a full charge rate in response to a determination that the RSSI value of the signal received by the wireless communication device 220 is above an impact threshold; a reduced charge rate in response to a determination that the RSSI value of the signal received by the wireless communication device is below an impact threshold, a determination that the charge state of the peripheral device is below a low-power threshold, and identification of an application executing on the computing device assigned network priority status; and disable charging in response to a determination that the connection quality metric of the wireless communication device is below an impact threshold and a determination that the charge state of the peripheral device is above a low-power threshold.

FIG. 2B illustrates another example computing device 250 with an NFC wireless charging system 230 that adjusts a charge rate of a peripheral device 235 based on an RSSI value of signal received by the WWAN wireless communication system. A charge state subsystem 260 determines the charge state of the peripheral device 235. A connection quality subsystem 270 determines the RSSI value of the wireless signal received by a WWAN wireless communication system. The charge rate subsystem 280 adjusts the charge rate of the NFC wireless charging subsystem based on a determined charge state of the peripheral device and the received RSSI value of the wireless signal reported by the WWAN wireless communication device.

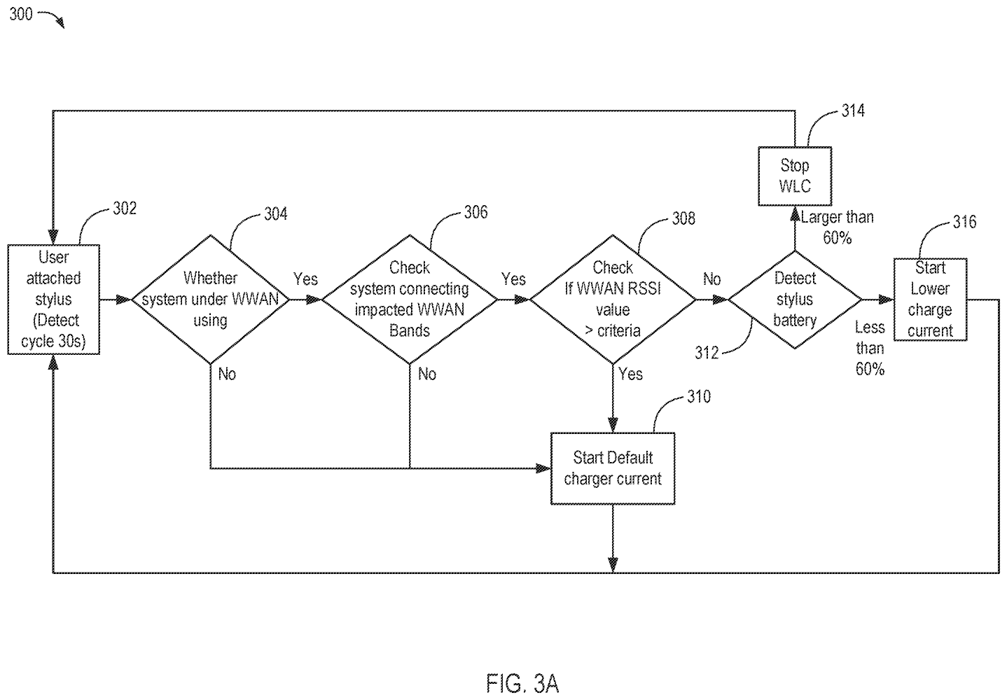

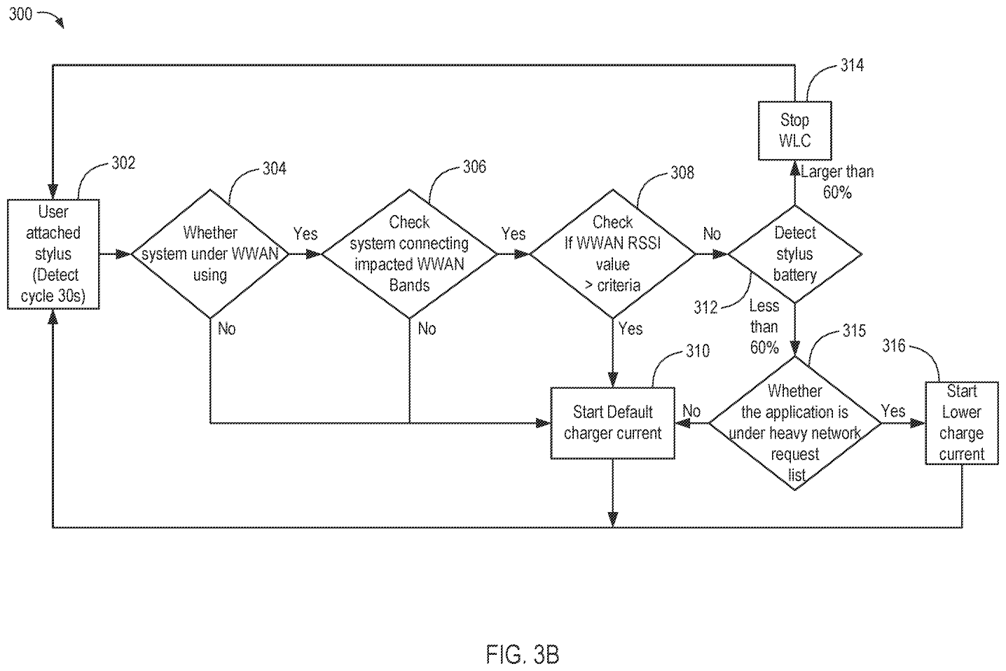

FIG. 3A illustrates a flow chart 300 of an example approach for controlling the wireless charge rate of a wireless charging system as a function of the impact on a wireless communication system. As illustrated, the system may detect, at 302, that a user has attached a stylus (or another peripheral device) to a computing device for wireless charging. The system may determine, at 304, if the wireless communication device (such as a WWAN communication device) is in use. If the wireless communication device is not in use, the computing device may initiate wireless charging at a default charging rate, at 310 (e.g., at a high or higher default charger current).

The system may determine the effect or impact that wireless charging has on the wireless communication system, at 306. If wireless charging is not impacting the wireless communication system by more than an acceptable threshold amount, wireless charging may continue at the default charging rate, at 310. For example, if an RSSI value of a wireless signal received by a wireless communication system satisfies acceptable criteria, at 308, the wireless charging system may continue to operate at the default charging rate, at 310.

If the RSSI value of the wireless signal received by the wireless communication system is below the criteria, at 308, and the stylus battery state of charge is above 60%, at 312, then wireless charging can be disabled to prevent or reduce further disruption to the wireless communication via the wireless communication device. However, if the battery state of charge of the peripheral device is less than 60%, at 312, the system may charge the peripheral device at a lower charge current, at 316. The lower charge current may reduce or minimize the interference caused by the wireless charging system in the communication band used by the wireless communication device.

FIG. 3B illustrates a flow chart of another example approach for controlling the wireless charge rate of a wireless charging system as a function of the impact on a wireless communication system. As illustrated, the system may detect, at 302, that a user has attached a stylus (or another peripheral device) to a computing device for wireless charging. The system may determine, at 304, if the wireless communication device (such as a WWAN communication device) is in use. If the wireless communication device is not in use, the computing device may initiate wireless charging at a default charging rate, at 310 (e.g., at a high or higher default charger current).

The system may determine the effect or impact that wireless charging has on the wireless communication system, at 306. If wireless charging is not impacting the wireless communication system by more than an acceptable threshold amount, wireless charging may continue at the default charging rate, at 310. For example, if an RSSI value of a wireless signal received by a wireless communication system satisfies acceptable criteria, at 308, the wireless charging system may continue to operate at the default charging rate, at 310.

If the RSSI value of the wireless signal received by the wireless communication system is below the criteria, at 308, and the stylus battery state of charge is above 60%, at 312, then wireless charging can be disabled to prevent or reduce further disruption to the wireless communication via the wireless communication device. However, if the battery state of charge of the peripheral device is less than 60%, at 312, the system may determine if applications currently executing on the computing device are on a heavy network request list or otherwise have a network priority status, at 315.

If an application executing on the computing device does have a network priority status, at 315, then the system may begin charging the peripheral device at a lower charge current, at 316. The lower charge current may reduce or minimize the interference caused by the wireless charging system in the communication band used by the wireless communication device. However, if the system determines that none of the applications currently executing on the computing device have been assigned a network priority status, at 315, then the system may begin charging the peripheral device with the default charger current, at 310.

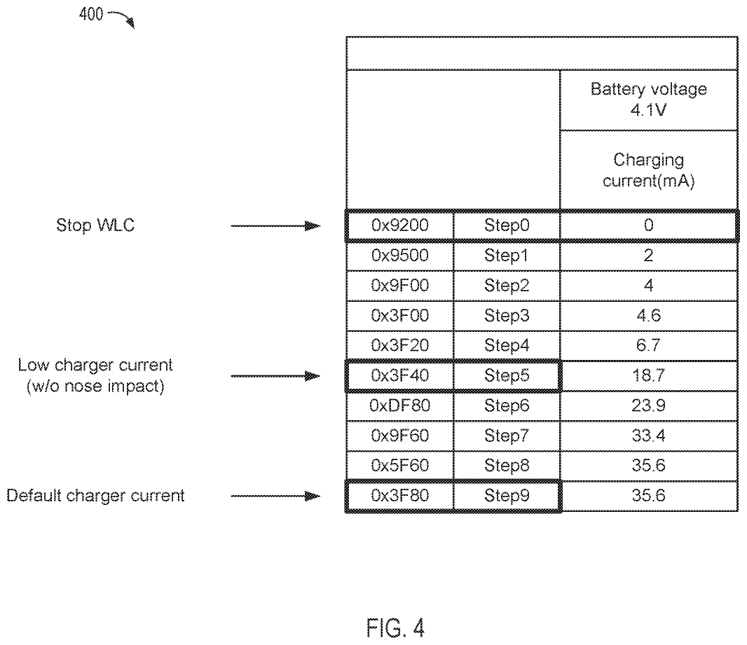

FIG. 4 illustrates a table of charge rates for an example NFC wireless charging system. A specific NFC wireless charging system may be programmed to stop wireless charging, such that the wireless charging system provides a charging current of 0 milliamps. The NFC wireless charging system may charge at a lower charger current (Step 5 charging) with 18.7 milliamps. In a default or high current charging state, the NFC wireless charging system may operate with Step 9 charging with 35.6 milliamps. In some embodiments, the system may adjust the charging rate used by the NFC wireless charging system to the maximum value that can be used while maintaining the RSSI value of a signal received by the wireless communication device above an established threshold.

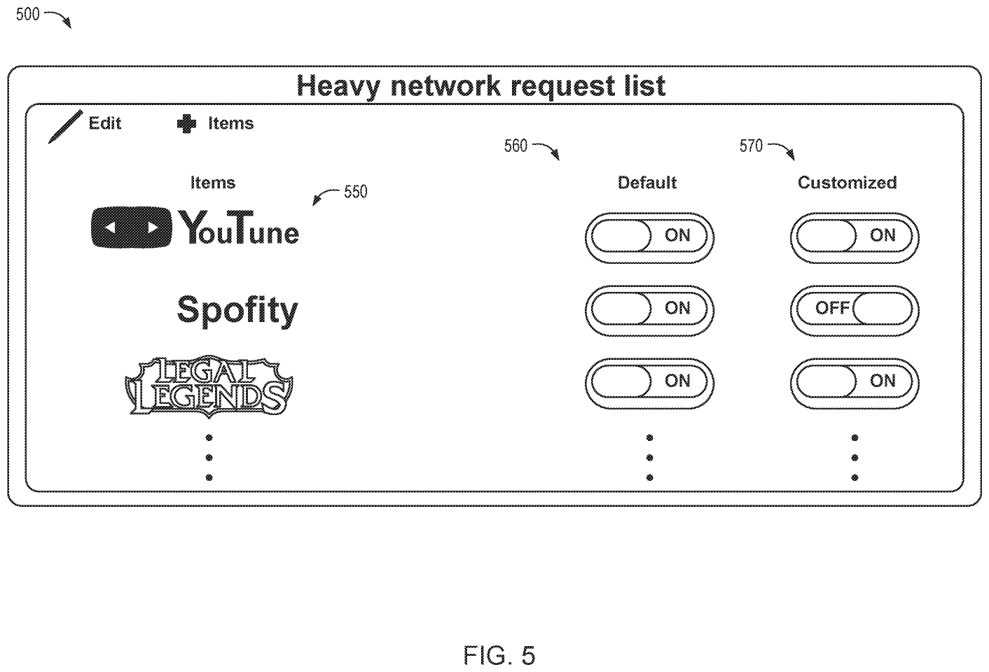

FIG. 5 illustrates an example graphical user interface 500 for a user to manually assign network priority status to individual applications. As illustrated, a user may assign a default, at 560, or a customized, 570, network priority status to each of a list of different applications 550.

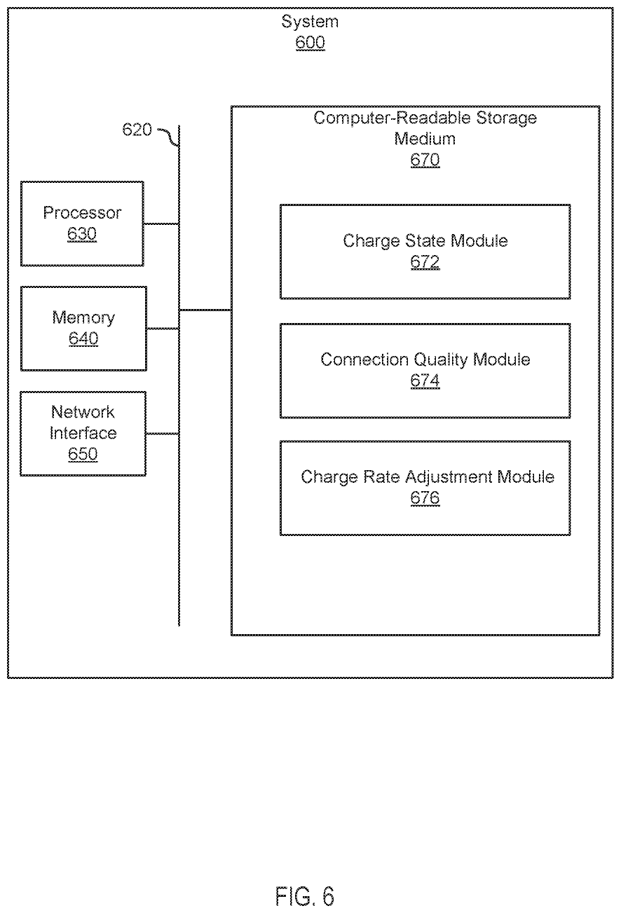

FIG. 6 illustrates a block diagram of an example system 600 with a wireless charging system and a wireless communication system. The system includes a bus 620 that connects a processor 630, a memory 640, a network interface, and a non-transitory computer-readable storage medium 670. The processor may execute instructions stored in the computer-readable storage medium 670 that may be arranged in various modules or blocks in one or more physical locations. For example, the non-transitory computer-readable medium 670 includes a charge state module 672 with instructions that, when executed by the processor 630, operate to determine a charge state of a peripheral device connected to the wireless charging system of the system 600. The non-transitory computer-readable medium 670 includes a connection quality module 674 with instructions that, when executed by the processor 630, operate to determine a connection quality metric (e.g., an RSSI value of a received signal) of a wireless communication device.

The non-transitory computer-readable medium 670 includes a charge rate adjustment module 676 with instructions that, when executed by the processor 630, operate to charge the peripheral device at a full charge rate in response to a determination that the connection quality metric of the wireless communication device is above an impact threshold, charge the peripheral device at a reduced charge rate in response to a determination that (i) the connection quality metric of the wireless communication device is below an impact threshold, and (ii) the charge state of the peripheral device is below a low-power threshold, and (c) disable charging of the peripheral device in response to a determination that (i) the connection quality metric of the wireless communication device is below an impact threshold and (ii) the charge state of the peripheral device is above a low-power threshold.

Specific examples of the disclosure are described above and illustrated in the figures. It is, however, appreciated that many adaptations and modifications can be made to the specific configurations and components detailed above. In some cases, well-known features, structures, and/or operations are not shown or described in detail. Furthermore, the described features, structures, or operations may be combined in any suitable manner. Thus, all feasible permutations and combinations of examples are contemplated. In the description above, various features are sometimes grouped together in a single example, figure, or description thereof for the purpose of streamlining the disclosure. This method of disclosure, however, is not to be interpreted as reflecting an intention that any claim now presented or presented in the future requires more features than those expressly recited in that claim. Rather, it is appreciated that inventive aspects lie in a combination of fewer than all features of any single foregoing disclosed example. The claims are hereby expressly incorporated into this Detailed Description, with each claim standing on its own as a separate example. This disclosure includes all permutations and combinations of the independent claims with their dependent claims.

What is claimed is:

1. A computing device, comprising:
a wireless communication device to facilitate wireless communication using a first band of electromagnetic radiation;
a wireless charging system to wirelessly charge a peripheral device using a second band of electromagnetic radiation, wherein wireless charging in the second band of electromagnetic radiation introduces harmonic interference in the first band of electromagnetic radiation; and
a processor to:
determine a charge state of the peripheral device,
determine a connection quality metric of the wireless communication device, and
adjust a charge rate of the wireless charging system as a function of the charge state of the peripheral device and the connection quality of the wireless communication device.

2. The computing device of claim 1, wherein the peripheral device comprises an input device selected from a group of input devices that includes a mouse, a keyboard, a stylus, a speaker, headphones, a microphone, and a camera.

3. The computing device of claim 1, wherein the computing device comprises a personal computing device selected from a group of personal computing devices that includes a mobile phone, a tablet computer, and a laptop computer.

4. The computing device of claim 1, wherein the connection quality metric of the wireless communication device is determined based on a receive signal strength indicator (RSSI) value of a communication signal received by the wireless communication device.

5. The computing device of claim 1, wherein the wireless charging system comprises a near-field communication (NFC) wireless charging system with the second band of electromagnetic radiation including electromagnetic radiation at 13.56 MHz, and,
wherein the wireless communication system comprises a wireless wide area network (WWAN) communication system with the first band of electromagnetic radiation including electromagnetic radiation between approximately 700 MHz and 900 MHz.

6. The computing device of claim 1, wherein the processor is further to:
(a) charge at a full charge rate in response to a determination that the connection quality metric of the wireless communication device is above an impact threshold;
(b) charge at a full charge rate in response to a determination that (i) the connection quality metric of the wireless communication device is below an impact threshold and (ii) the charge state of the peripheral device is below a low-power threshold; and
(c) disable charging in response to a determination that (i) the connection quality metric of the wireless communication device is below an impact threshold and (ii) the charge state of the peripheral device is above a low-power threshold.

7. The computing device of claim 6, wherein the low-power threshold comprises a state of charge percentage less than 60%,
wherein the connection quality metric of the wireless communication device is determined based on a receive signal strength indicator (RSSI) value of a communication signal received by the wireless communication device, and
wherein the impact threshold is a threshold RSSI value.

8. The computing device of claim 1, wherein the instructions, when executed by the processor, further operate to:
analyze applications executing on the computing device to identify an application assigned network priority status, and
adjust the charge rate of the wireless charging system as a function of the charge state of the peripheral device, the connection quality metric of the wireless communication device, and the identification of an application assigned network priority status.

9. The computing device of claim 8, wherein the connection quality metric of the wireless communication device is determined based on a receive signal strength indicator (RSSI) value of a communication signal received by the wireless communication device, and
wherein the instructions, when executed by the processor, operate to adjust the charge rate of the wireless charging system to:
(a) charge at a full charge rate in response to a determination that the RSSI value an impact threshold;
(b) charge at a reduced charge rate in response to (i) a determination that the RSSI value is below an impact threshold, (ii) a determination that the charge state of the peripheral device is below a low-power threshold, and (iii) identification of an application assigned network priority status; and
(c) disable charging in response to (i) a determination that the connection quality metric of the wireless communication device is below an impact threshold and (ii) a determination that the charge state of the peripheral device is above a low-power threshold.

10. The computing device of claim 9, wherein the low-power threshold comprises a state of charge percentage below 60%, and
wherein the impact threshold is a threshold RSSI value.

11. A non-transitory computer-readable medium with instructions stored thereon that, when executed by a processor of a computing device, cause the computing device to:
determine a charge state of a peripheral device connected to a wireless charging system of the computing device,
determine a connection quality metric of a wireless communication device, and
set a charge rate of the wireless charging system to:
(a) charge at a full charge rate in response to a determination that the connection quality metric of the wireless communication device is above an impact threshold,
(b) charge at a reduced charge rate in response to a determination that (i) the connection quality metric of the wireless communication device is below an impact threshold, and (ii) the charge state of the peripheral device is below a low-power threshold, and
(c) disable charging in response to a determination that (i) the connection quality metric of the wireless communication device is below an impact threshold and (ii) the charge state of the peripheral device is above a low-power threshold.

12. The non-transitory computer-readable medium of claim 9, wherein the low-power threshold comprises a charge state percentage between 20% and 80%,
wherein the connection quality metric of the wireless communication device is determined based on a receive signal strength indicator (RSSI) value of a communication signal received by the wireless communication device, and
wherein the impact threshold comprises a threshold RSSI value.

13. The non-transitory computer-readable medium of claim 9, wherein the peripheral device comprises a peripheral device selected from a group of peripheral devices that includes a mouse, a keyboard, a stylus, a speaker, headphones, a microphone, and a camera.

14. A computing device, comprising:
an adjustable near-field communication (NFC) wireless charging subsystem to wirelessly charge a peripheral device using a first band of electromagnetic radiation at a selectable charge rate;
a charge state subsystem to determine a charge state of the peripheral device;
a connection quality subsystem to determine an RSSI value of a wireless signal reported by a wireless wide area network (WWAN) wireless communication device operating in a second band of electromagnetic radiation; and
a charge rate subsystem to adjust the charge rate of the NFC wireless charging subsystem based on a determined charge state of the peripheral device and the received RSSI value of the wireless signal reported by the WWAN wireless communication device.

15. The wireless charge controller of claim 14, wherein the peripheral device comprises a peripheral device selected from a group of peripheral devices that includes a mouse, a keyboard, a stylus, a speaker, headphones, a microphone, and a camera.
